(19) United States
(12) Patent Application Publication
(10) Pub. No.: US 2026/0138888 A1
(43) Pub. Date: May 21, 2026

(54) FILTERED BEVERAGE CONTAINER

(71) Applicant: The Coleman Company, Inc., Wichita, KS (US)

(72) Inventors: James Bergman, Sugar Grove, IL (US); Melissa Wolf, Roswell, GA (US); Shirish Patel, Schaumburg, IL (US)

(21) Appl. No.: 19/394,313

(22) Filed: Nov. 19, 2025

Related U.S. Application Data
(60) Provisional application No. 63/722,775, filed on Nov. 20, 2024.

(51) Int. Cl. C02F 1/00

(52) U.S. Cl. CPC C02F 1/002; C02F 2307/02

(57) ABSTRACT

A beverage container is provided that includes a main chamber fluidly connected to an introduction chamber by a filter. A user may introduce liquid into the beverage container at the introduction chamber, and the liquid can flow from the introduction chamber into the main chamber through the filter. The filter preferably enables the user to instantly or nearly instantly filter the liquid as soon as it is introduced into the container, or shortly after the liquid is introduced. The filtered liquid can then be stored in the beverage container for consumption at the user's convenience.

### CROSS-REFERENCE TO RELATED APPLICATIONS

This application claims priority to and the benefit of U.S. Provisional Ser. No. 63/722,775 , filed Nov. 20, 2024, the entire disclosure of which is hereby incorporated herein by reference.

### FIELD

The present disclosure relates generally to beverage containers including a filter, and more particularly to beverage containers that can filter a liquid (e.g., water) as soon as, or shortly after, the liquid is introduced into the container.

### BACKGROUND

It is challenging for consumers to filter water “on the go.” As such, some consumers purchase bottled water or resort to drinking unfiltered tap water. Bottled water is expensive, and the empty bottle creates waste that can be environmentally harmful. On the other hand, unfiltered tap water may contain chemicals and particulates that give the water an unpleasant taste or may be harmful to the user.

To give consumers easy access to filtered water on the go, manufacturers have developed reusable water bottles incorporating water filters. Typically, these filtered bottles are provided as squeeze bottles or, alternatively, as bottles with a straw. Both types of filtered bottles present issues for users.

Squeeze-style filtered bottles require that the user squeeze the outside surface of the bottle to force water through the filter and out of the bottle. Unfortunately, users with limited hand strength cannot squeeze the bottle with enough force to drive water through the filter and out of the bottle. Also, it is extremely difficult to maintain a continuous flow of water out of the bottle, making this type of filtered water bottle unpleasant and inconvenient for the user.

Straw-style filtered bottles require a user to apply suction via a straw to draw water through the filter and out of the bottle. Straws are inconvenient since they must be periodically cleaned and can be misplaced when taken out of the bottle. Further, people with limited lung capacity may not be able to draw water through the filter and up the straw, preventing them from being able to adequately use the bottle.

### SUMMARY OF THE DISCLOSURE

Described herein are filtered beverage containers (e.g., water bottles) that overcome many of the shortcomings and limitations of the filtered water bottles discussed above. In general, the filtered beverage containers of the present disclosure include a filter assembly that operates to filter liquid (e.g., water) when the liquid is introduced in the container. As a result, the liquid stored in the container comprises a volume of filtered liquid that can be enjoyed at the user's convenience. Additionally, since the liquid is filtered when introduced to the container, the user's ability to drink the water is not hindered or made inconvenient by any filter mechanism that operates in conjunction with the drinking process. For example, the user does not need to suck the liquid through a straw filter or squeeze the liquid through a filter when drinking the liquid to enjoy filtered liquid. As such, the overall drinking process and experience using the beverage container is more convenient and enjoyable without sacrificing the benefits that filtered liquid provides.

These and other aspects and advantages will become apparent to those skilled in the art after considering the following detailed description in connection with the accompanying drawings.

### BRIEF DESCRIPTION OF DRAWINGS

FIG. 1 is a side, partial section view of a filtered beverage container according to a first embodiment;

FIG. 2 is a top view of a removable filter housing used with the container of FIG. 1;

FIG. 3 is a side elevation view of the filter housing of FIG. 2;

FIG. 4 is a perspective view of a filtered beverage container according to a second embodiment.

FIGS. 5 and 6 are interior views of the filtered beverage container of FIG. 4 and depict a sequence of the container in use for filtering liquid therein wherein the container moves between a first configuration (FIGS. 4 and 6) and a second configuration (FIG. 5); and

FIG. 7 is a perspective of a filtered beverage container according to a third embodiment.

While the disclosure is susceptible to various modifications and alternative forms, a specific embodiment thereof is shown by way of example in the drawings and will herein be described in detail. It should be understood, however, that the drawings and detailed description presented herein are not intended to limit the disclosure to the particular embodiment disclosed, but to the contrary, the intention is to cover all modifications, equivalents, and alternatives falling within the spirit and scope of the present disclosure as defined by the appended claims.

### DETAILED DESCRIPTION

One or more specific embodiments of the present disclosure will be described herein. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, references to “one embodiment” or “an embodiment” of the present disclosure are not intended to be interpreted as excluding the existence of additional embodiments that also incorporate the recited features.

Described herein are beverage containers (e.g., water bottles) that include a filter operable to filter a liquid (e.g., water) when the liquid is introduced into the container (e.g., as soon as, or shortly after, the liquid is introduced into the container). The filtered beverage containers may thereby contain a volume of filtered liquid that is available to drink at a user's convenience. Beverage containers described herein may have a first end from which the user can consume the liquid and a second end from at the user can introduce the liquid into the container for filling and filtering. The beverage container may include a filter proximate the second end which separates an introduction chamber from a main chamber, and liquid can be directed from the introduction chamber into the main chamber through the filter when (e.g., during and/or immediately after) the liquid is introduced into the container. The filtered liquid may then be contained in the main chamber and ready to be enjoyed at the user's convenience.

In some embodiments, the beverage container may have a “filter, flip, and sip” design, where the container is in a first orientation during the filling and filtering process that enables the filtered liquid to flow from the introduction chamber into the main chamber by gravity, and the user can then flip the container to a second orientation for accessing the first end and consuming the filtered liquid. In these embodiments, a one-way valve may be provided to allow the liquid to flow from the introduction chamber into the main chamber when the container is in the first orientation, and the one-way valve may also prevent backflow of the filtered liquid from the main chamber into the introduction chamber when the container is in the second orientation.

In some embodiments, the beverage container has a dual casing configuration, with an inner casing and an outer casing being concentrically and coaxially arranged and moveable relative to one another in a telescoping manner between a compressed/closed configuration of the container and an expanded/open configuration of the container. During filling, the container is in the expanded configuration and the liquid is introduced into the introduction chamber defined by the outer casing. The container can then be moved to the compressed configuration by pushing or pressing the inner casing into the outer casing, whereby the liquid is directed through the filter into the main chamber defined by the inner casing via volume displacement.

In some embodiments, the beverage container includes an adapter (e.g., a silicone tube) that defines the introduction chamber and is configured to attached at one end to a filtered port of the beverage container and at another end to a pressurized liquid supply (e.g., a faucet). Pressurized liquid can then flow through the adapter and the filtered port, and into the main chamber of the beverage container.

In some embodiments, the unfiltered liquid can be introduced to the beverage container at a first end and filtered, and the filtered liquid can be consumed at a second end of the beverage container that is different from the first end (e.g., the first end is opposite the second end). This may avoid any cross-contamination between the filtered and unfiltered liquid.

In some embodiments, the beverage containers described herein are portable water bottles that allow the user to enjoy filtered liquid on the go.

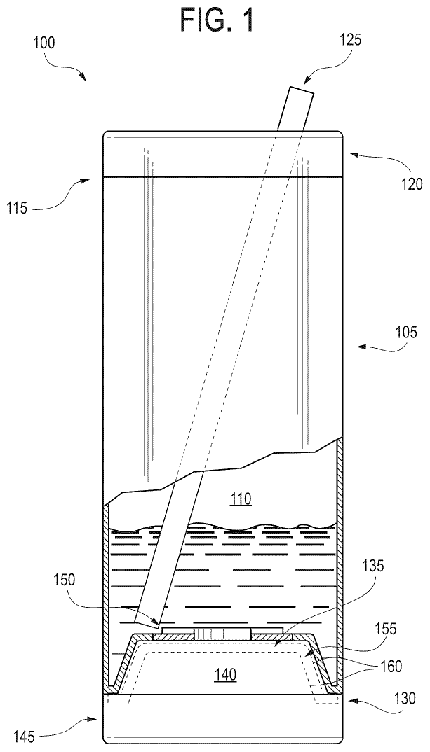

FIG. 1 depicts a beverage container, e.g., a filtered water bottle 100, according to a first embodiment. The bottle 100 may have a “filter, flip, and sip” design that enables a user to simultaneously, or nearly simultaneously, introduce a liquid (e.g., water) into the bottle 100 and filter the liquid when the bottle 100 is in a first orientation (e.g., rotated 180° relative to the orientation in FIG. 1). The user may then rotate or flip the bottle 100 to the orientation shown in FIG. 1 for consuming the filtered liquid. The filtered liquid may be contained in a main chamber 110 defined by a body 105 of the bottle 100. A user may be able to introduce and filter the liquid at a second end 130 of the body 105 and to consume the filtered liquid at a first end 115 of the body 105. When unfiltered liquid (e.g., tap water) is introduced at the second end 130, the liquid may be temporarily contained in an introduction chamber 140, before it flows through a filter assembly 135 (e.g., a filter housing or a filter cup) and into the main chamber 110. In the first orientation of the bottle 100, gravity may serve as the motive force for flow of the liquid between the introduction chamber 140 and the main chamber 110 through the filter assembly 135. In the second orientation of the bottle 100, backflow of the filtered liquid between the main chamber 110 and the introduction chamber 140 may be prevented via a one-way valve 150 or other backflow prevention device.

The body 105 of the water bottle 100 may be in the form of a hollow tube (e.g., hollow cylinder) with a sidewall that extends between the first end 115 and the second end 130 and defines the main chamber 110. The body 105 may enclose the filtered liquid in the main chamber 110. The body 105 may be made of any suitable material, such as resilient waterproof material (e.g., plastic). The body 105 may be at least partially open at both ends 115, 130. In some embodiments, a filtered liquid outlet may be defined at or proximate the first end 115 and an unfiltered liquid inlet may be defined at or proximate the second end 130. To close the bottle 100 and seal the contents of the main chamber 110, a lid 120 may be attached to the first end 115 of the body 105 and may prevent the filtered liquid from prematurely or inadvertently exiting the main chamber 110. Additionally, a bottom cover 145 may be attached to the second end 130 of the body 105 and may seal the introduction chamber 140 to prevent undesired ingress of fluid or contaminants into the main chamber 110 through the filter assembly 135.

The lid 120 may be configured to enable the user to consume the filtered liquid at the first end 115. For example, the lid 120 may be releasably attached to the body 105 (e.g., via threaded engagement or friction fit) and the lid 120 can be removed (e.g., by twisting and/or pulling) from the body 105 to allow access to the volume of filtered liquid in the main chamber 110. Additionally, or alternatively, the lid 120 may include a drinking mechanism 125 that selectively allows the filtered liquid to pass through the lid 120 from the main chamber 110 when the user desires to consume the filtered liquid. For example, in the illustrated embodiment, the drinking mechanism 125 may include a straw that the user can use to suck the filtered liquid from the main chamber 110 through the lid 120. The drinking mechanism 125 may additionally or alternatively include any suitable mechanism to enable a user to consume the filtered liquid through the lid 120, such as a spout for example. The drinking mechanism 125 is suitably sealable or closeable to prevent liquid from prematurely or inadvertently leaking or spilling from the main chamber 110. For example, the drinking mechanism 125 may be sealed to prevent the liquid from leaking or spilling from of the main chamber 110 when the water bottle 100 is in the first orientation. Sealing the drinking mechanism 125 can be enabled using, for example, a closeable cap, a closeable spout or outlet, a check valve (e.g., one way valve straw or a duck bill valve for a spout), or another suitable means.

The bottom cover 145 may also be releasably attached to the body 105 (e.g., via threaded engagement or friction fit) and the bottom cover 145 can be removed (e.g., by twisting and/or pulling) from the body 105 to allow access to the introduction chamber 140. For example, the bottom cover 145 may be removed by the user when the user desires to introduce liquid at the second end 130 for adding or replenishing filtered liquid in the main chamber 110.

The filter assembly 135 (e.g., a filter housing or filter cup) may be positioned in the body 105 proximate the second end 130. The filter assembly 135 may separate and/or may be positioned between the main chamber 110 and the introduction chamber 140. The filter assembly 135 may include or may be positioned adjacent the one-way valve 150, or another suitable backflow prevention device. The one-way valve 150 may allow the liquid to flow from the introduction chamber 140 into the main chamber 110 (e.g., by gravity when the bottle 100 is in the first orientation), and the one-way valve 150 may also prevent backflow of the filtered liquid from the main chamber 110 into the introduction chamber 140 (e.g., when the bottle 100 is in the second orientation).

The filter assembly 135 may include (e.g., house or enclose) a filter medium 155 facing the introduction chamber 140. The filter medium 155 may be exposed to the liquid (e.g., via a porous or liquid-permeable film 160) and may operate to filter the liquid as it passes through the filter assembly 135 between the introduction chamber 140 and the main chamber 110. For example, the filter medium 155 may remove chemicals and particulates from the water passing through the filter assembly 135 (e.g. chlorine and dissolved solids). The filter medium 155 may therefore include any suitable filter material that enables the filter medium 155 to function as described including, for example and not limited to including, gravel, resin, catalytic carbon, and the like. The filter medium 155 may be removable, e.g., once it has reached the end of its useful life, and the user may install another filter medium 155 for continued use of the bottle 100. The filter medium 155 itself may be removable and replaceable, or the filter assembly 135 including the filter medium 155 may be removable and replaceable.

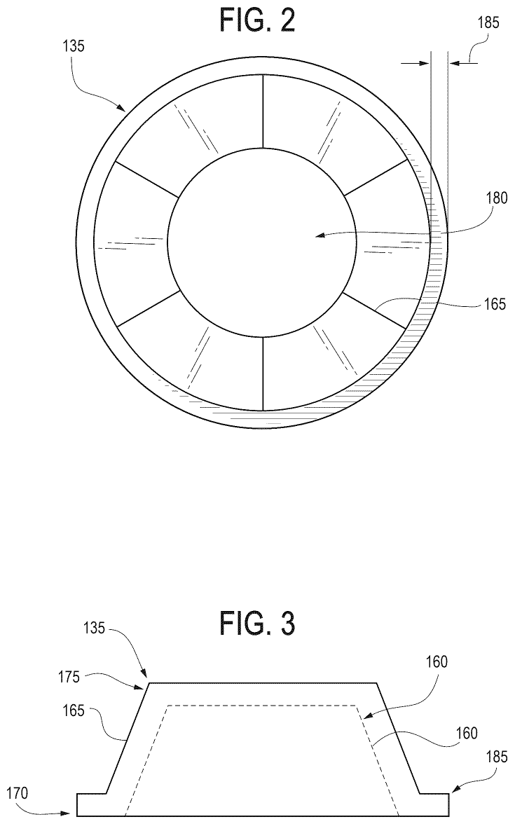

Referring now to FIGS. 2 and 3, in one example, the filter assembly 135 may include a sidewall 165 extending between a bottom 170 of the filter assembly 135 and a top 175 of the filter assembly 135. When the filter assembly 135 is installed in the bottle 100 (as shown in FIG. 1), the bottom 170 is located proximate the second end 130 of the body 105 and the top 175 is located between the introduction chamber 140 and the main chamber 110. The sidewall 165 may taper in dimension (e.g., diameter) between the bottom 170 and the top 175, and may define a cup or frustum shape of the filter assembly (e.g., a frusto-conical shape). The sidewall 165 may surround the introduction chamber 140, and the tapered profile of the sidewall 165 may guide the liquid through the introduction chamber 140 towards the top 175.

The filter assembly 135 may include a central opening 180 defined at the top 175, which may allow the liquid to flow therethrough between the introduction chamber 140 and the main chamber 110. The one-way valve 150 (shown in FIG. 1) may be positioned in or adjacent the central opening 180. The filter medium 155, which may be housed or enclosed by the liquid-permeable film 160, may be located beside the sidewall 165 and across the central opening 180 in the top 175 such that the liquid passes entirely through the filter medium 155 when flowing from the introduction chamber 140 into the main chamber 110. The liquid can permeate the film 160 to pass through the filter medium 155. Suitably, the film 160 may be permeable to the liquid and impermeable to the filter medium 155 to prevent the filter medium 155 from becoming entrained in the liquid when entering the main chamber 110.

When the filter assembly 135 is installed in the bottle 100 (as shown in FIG. 1), the attachment between the bottom cover 145 and the second end 130 of the body 105 may secure the filter assembly 135 in the body 105. For example, the bottom 170 may include an outwardly extending flange 185 that may be seated between the second end 130 of the body 105 and the bottom cover 145. When the bottom cover 145 is attached to the second end 130 of the body 105, the flange 185 may be sealed therebetween to prevent movement of the filter assembly 135 in the body 105. The filter assembly 135 may become unsealed when the bottom cover 145 is removed from the body 105, enable easy removal and replacement thereof. Additionally, when the bottle 100 is in the first orientation, the flange 185 may be seated on the second end 130 of the body 105 such that the liquid being introduced into the introduction chamber 140 does not cause significant movement of the filter assembly 135 relative to the body 105 which could otherwise interfere with the filtering process.

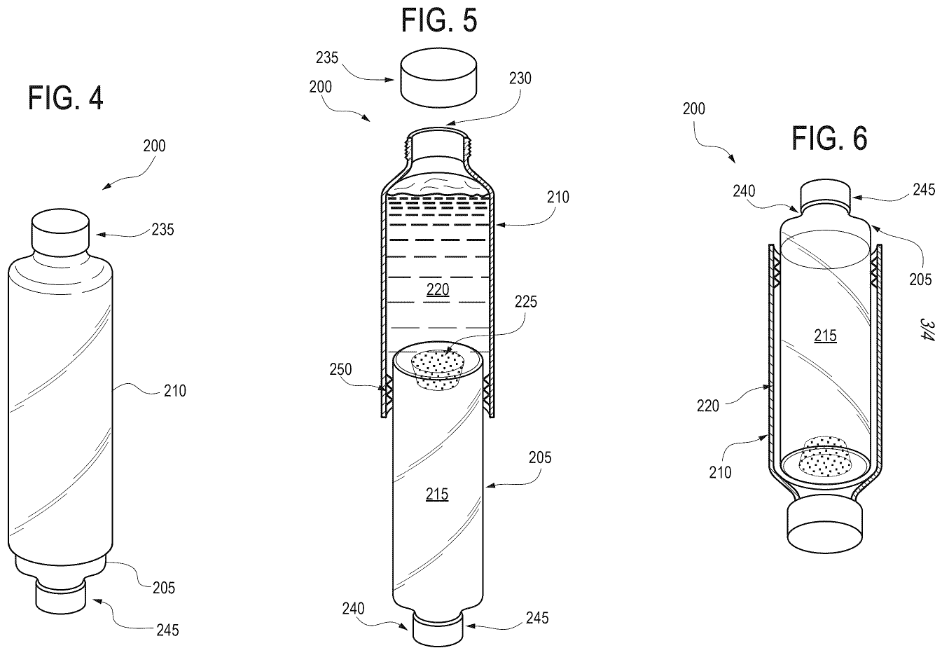

Referring now to FIG. 4, in a second embodiment, a beverage container, e.g., a filtered water bottle 200, may include a filter, flip, and sip design with a dual casing configuration that enables filtering liquid (e.g., water) in the bottle 200 by press-filtering and volume displacement. The filtered water bottle 200 in this example may include a first (or inner) casing 205 and a second (or outer) casing 210. The inner casing 205 may be concentrically and coaxially arranged with the outer casing 210, and the inner casing 205 may be moveable relative to the outer casing 210 in a telescoping manner. Movement of the inner casing 205 and the outer casing 210, depicted in the sequence of FIGS. 4-6, may be move the bottle 200 between a first (or compressed) configuration (shown in FIGS. 4 and 6) and a second (expanded) configuration (shown in FIG. 5).

Referring to FIG. 5, when the bottle 200 is in the expanded configuration, the bottle 200 may be oriented in a first orientation (e.g., the orientation shown in FIGS. 4 and 5) and unfiltered liquid (e.g., tap water) may be introduced into an introduction chamber 220 defined by the outer casing 210. The outer casing 210 may define an open first end 230 of the bottle 200, which can be selectively sealed or closed with a cap 235. In some embodiments, an unfiltered liquid inlet may be defined at or proximate the open first end 230. The cap 235 may threadedly engage the open first end 230 to releasably attach the cap 235 to the outer casing 210. The cap 235 may be removed to fill the introduction chamber 220 with liquid via the first open end 230, and the cap 235 may then be attached to close the introduction chamber 220 and prevent the liquid from leaking or spilling from the bottle 200.

The introduction chamber 220 may also be sealed using one or more mechanical seals 250 (e.g., elastomeric seals or O-rings) positioned between the inner casing 205 and the outer casing 210. The mechanical seals 250 may create a fluid-tight seal that prevents liquid from leaking or spilling from the bottle 200 during a filtering process. The mechanical seal 250 may allow the inner casing 205 to move relative to the outer casing 210 without breaking the seal. For example, the inner casing 205 may slide across the seal 250 when pressed into the outer casing 210 without breaking the seal between the inner casing 205 and the outer casing 210. In the illustrated embodiment, the mechanical seals 250 may be coupled or affixed to an inner wall of the outer casing 210 and positioned adjacent an outer wall of the inner casing 205.

The introduction chamber 220 can be fluidly connected with a main chamber 215 defined by the inner casing 205, such that the liquid in the introduction chamber 220 can flow into the main chamber 215. A filter assembly 225 (e.g., a filter cup) is preferably positioned between the introduction chamber 220 and the main chamber 215. The filter assembly 225 may operate similar to the filter assembly 135 described above to filter the water as it flows from the introduction chamber 220 into the main chamber 215. The filter assembly 225 may include any suitable filter medium, including but not limited to the filter materials described above for the filter medium 155.

Referring to FIG. 6, after filling the introduction chamber 220 with unfiltered liquid, the inner casing 205 may then be pressed into the outer casing 210, moving the bottle 200 to the compressed configuration and directing the liquid through the filter assembly 225 and into the main chamber 215. Pressing the inner casing 205 into the outer casing 210 may reduce a volume of the introduction chamber 220, which may pressurize the unfiltered liquid therein. The introduction chamber 220 and the main chamber 215 may be sealed via the mechanical seal(s) 250 and fluidly connected via the filter assembly 225. The liquid in the introduction chamber 220 may be forced through the filter assembly 225 and into the main chamber 215 via volume displacement when the bottle 200 is moved to the compressed configuration.

When the filtered liquid has entered the main chamber 215 via the press-filter process, the user may rotate or flip the bottle 200 to the orientation shown in FIG. 6 for consuming the filtered liquid. The inner casing 205 may include a second open end 240 of the bottle 200 to allow the user to consume the filtered liquid. In some embodiments, a filtered liquid outlet may be defined at or proximate the second open end 240. The second open end 240 may be selectively sealed or closed with a cap 245. The cap 245 may threadedly engage the open second end 240 to releasably attach the cap 245 to the inner casing 205. The cap 245 may be removed to allow the user to consume the filtered liquid via the second open end 240, and the cap 245 may then be attached to close the main chamber 215 and prevent the liquid from leaking or spilling from the bottle 200.

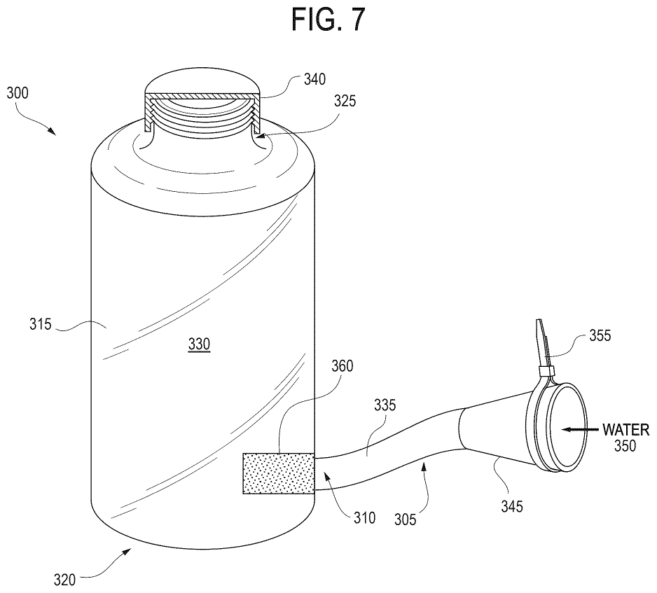

Referring now to FIG. 7, in a third embodiment, a beverage container, e.g., a filtered water bottle 300, may include a filter, flip, and sip design with an adapter 305 for receiving unfiltered liquid (e.g., tap water) directly from a pressurized liquid supply (e.g., a faucet) and delivering the unfiltered liquid into the bottle 300 through a filtered port 310 of the bottle 300. The bottle 300 in this example may include a body 315 that defines the filtered port 310 proximate a first end 320 (or bottom). The body 315 also defines a main chamber 330 that receives filtered liquid via the port 310. The body 315 may have an open second end 325 (or top) from which a user can consume filtered liquid contained in the main chamber 330. In some embodiments, a filtered liquid outlet may be defined at or proximate the open second end 325 and an unfiltered liquid inlet may be defined at or proximate the first end 321.

The open second end 325 of the body 315 may be selectively closed or sealed with a cap 340. The cap 340 may be releasably attached to the body 315 (e.g., via threaded engagement or friction fit) and the cap 340 can be removed (e.g., by twisting and/or pulling) from the body 315 to allow access to the volume of filtered liquid in the main chamber 330.

The adapter 305 may include a flexible hose or tube 335 defining an introduction chamber or introduction conduit. The tube 335 can be made of any suitable material that is compatible with the liquid, such as silicone for example. The tube 335 may extend from a first end connected to the filtered port 310 and a second end that includes an attachment or docking member 345. The first end may be permanently or removably attached to the filtered port 310. The attachment member 345 may be sized and shaped to fit over a liquid supply outlet (e.g., a faucet or spout). The attachment member 345 may define an unfiltered liquid inlet 350 for receiving pressurized liquid from the liquid supply outlet. In this example, the attachment member 345 may have a nose cone shape that can fit over the liquid supply outlet. A cinching member 355 (e.g., a flexible tie, drawstring, or clamp) may be operably coupled with the attachment member 345. The cinching member 355 can be deployed (e.g., cinched or drawn) when the attachment member 345 is fit over the liquid supply outlet to create a fluid-tight seal therebetween. Deploying the cinching member 355 preferably does not interfere with the liquid inlet 350.

When the attachment member 345 is fit over and sealed to the liquid supply outlet, the pressurized, unfiltered liquid can be directed into the tube 335 via the liquid inlet 350. The pressurized liquid flows through the introduction conduit and through the filtered port 310. The filtered port may include a filter medium 360 (e.g., filter materials such as those described above) that filters the liquid as it flows through the filtered port 310 into the main chamber 330. The liquid pressure via the liquid supply (e.g., a faucet) preferably drives the unfiltered liquid across the filter medium 360 into the main chamber 330. The filter medium 360, in some examples, may be removable and replaceable, e.g., once it has reached the end of its useful life, and the user may install another filter medium 360 for continued use of the bottle 300. In some examples, the bottle 300 may be in a first orientation (e.g., rotated 180° relative to the orientation shown in FIG. 7) during the filling and filtering process, and the user can then flip the bottle to a second orientation (e.g., the orientation of FIG. 7) for accessing the open second end 325 and consuming the filtered liquid.

The filtered water bottles 100, 200, 300 of this disclosure enable access to a volume of filtered liquid (e.g., filtered water) while a user is on the go without sacrificing the usability of the bottle or inconveniencing the user when consuming the filtered liquid. The user may be able to introduce unfiltered liquid into the bottle at one end, and the unfiltered liquid can be filtered instantly, during or shortly after being introduced into the bottle. The filtered liquid can then be stored in a main chamber of the bottle. The user can then flip the bottle and consume the filtered liquid at another end of the bottle. The user thus has quick access to the filtered liquid and preferably does not need to alter the way they consume the liquid to perform the filtering process. Additionally, the user may consume the filtered liquid at an end of the bottle that is different from (e.g., opposite to) the end at which the unfiltered liquid is introduced, which may avoid cross-contamination between the filtered and unfiltered liquid (e.g., by unfiltered liquid splashing into the filtered liquid zone or chamber).

As is evident from the foregoing description, certain aspects of the present invention is not limited by the particular details of the examples illustrated herein, and it is therefore contemplated that other modifications, applications, variations, or equivalents thereof, will occur to those skilled in the art. Many such changes, modifications, variations and other uses and applications of the present constructions will, however, become apparent to those skilled in the art after considering the specification and the accompanying drawings. In addition, unless mention was made above to the contrary, it should be noted that all of the accompanying drawings are not to scale. All such changes, modifications, variations and other uses in applications which do not depart from the spirit and scope of the present inventions are deemed to be covered by the inventions which are limited only by the claims which follow.

1. A beverage container comprising:
a main chamber for containing a volume of filtered liquid, wherein the main chamber is fluidly connected to a filtered liquid outlet;
an introduction chamber fluidly connected an unfiltered liquid inlet for receiving and temporarily containing a volume of unfiltered liquid, wherein the introduction chamber is fluidly connected to the main chamber; and
a filter positioned between the main chamber and the introduction chamber, wherein the filter is configured to filter the unfiltered liquid flowing into the main chamber from the introduction chamber to produce the filtered liquid.

2. The beverage container of claim 1 having a first end and a second end, wherein the filtered liquid outlet is positioned proximate the first end and the unfiltered liquid inlet is positioned proximate the second end.

3. The beverage container of claim 2, wherein the introduction chamber is configured receive the unfiltered liquid via the unfiltered liquid inlet in a first orientation of the beverage container, and wherein the filtered liquid in the main chamber is accessible via the filtered liquid outlet in a second orientation of the beverage container substantially opposite from the first orientation.

4. The beverage container of claim 3, wherein gravity provides a motive force for the unfiltered liquid to flow through the filter into the main chamber from the introduction chamber when the beverage container is in the first orientation.

5. The beverage container of claim 1, further comprising:
a first casing defining the main chamber and the filtered liquid outlet; and
a second casing defining the introduction chamber and the unfiltered liquid inlet;
wherein the first casing and the second casing are moveable relative to one another.

6. The beverage container of claim 5, wherein the first casing and the second casing are concentrically and coaxially arranged and moveable relative to one another in a telescoping manner between a compressed configuration of the beverage container and an expanded configuration of the beverage container.

7. The beverage container of claim 6, wherein one or more mechanical seals are positioned between the first casing and the second casing.

8. The beverage container of claim 6, wherein the introduction chamber is configured to receive the unfiltered liquid via the unfiltered liquid inlet in the expanded configuration of the beverage container.

9. The beverage container of claim 8, wherein movement of the beverage container from the expanded configuration to the compressed configuration causes the unfiltered liquid to flow through the filter into the main chamber from the introduction chamber via volume displacement.

10. The beverage container of claim 1, further comprising:
a body defining the main chamber and the filtered liquid outlet; and
an adapter connected to the body, the adapter defining the introduction chamber and the unfiltered liquid inlet.

11. The beverage container of claim 10, wherein the adapter comprises a tube.

12. The beverage container of claim 11, wherein the tube is a silicone tube.

13. The beverage container of claim 10, wherein the adapter is configured to receive the unfiltered liquid from a liquid supply that provides a motive force for the unfiltered liquid flowing through the filter into the main chamber from the introduction chamber.

14. The beverage container of claim 1, wherein a motive force for the unfiltered liquid flowing through the filter into the main chamber from the introduction chamber is provided independent of a drinking mechanism of the beverage container.

15. The beverage container of claim 1, wherein the filter is removable and replaceable.

16. A beverage container comprising:
a filtered liquid outlet;
an unfiltered liquid inlet;
a chamber fluidly connected to the filtered liquid outlet and to the unfiltered liquid inlet; and
a filter positioned between the chamber and the unfiltered liquid inlet;
wherein the beverage container is moveable between a first orientation, in which unfiltered liquid flows through the unfiltered liquid inlet and the filter to produce filtered liquid that is contained in the chamber, and a second orientation, in which the filtered liquid is accessible in the chamber via the filtered liquid outlet.

17. The beverage container of claim 16, wherein the first orientation and the second orientation are approximately 180° from one another.

18. The beverage container of claim 16, wherein a motive force for the unfiltered liquid flowing through the filter into the chamber is provided via at least one of gravity, volume displacement, or pressure from a liquid supply.

19. A beverage container comprising:
a filtered liquid outlet;
an unfiltered liquid inlet;
a chamber fluidly connected to the filtered liquid outlet and to the unfiltered liquid inlet; and
a filter positioned between the chamber and the unfiltered liquid inlet;
wherein unfiltered liquid flows through the unfiltered liquid inlet and the filter into the chamber to produce filtered liquid that is contained in the chamber and accessible via the filtered liquid outlet; and
wherein a motive force for the unfiltered liquid to flow through the filter into the chamber is provided via at least one of gravity, volume displacement, or pressure from a liquid supply.

20. The beverage container of claim 19, wherein the unfiltered liquid comprises unfiltered water.
